(19) United States
(12) Patent Application Publication
(10) Pub. No.: US 2010/0220582 A1
(43) Pub. Date: Sep. 2, 2010

(54) DISC-SHAPED INFORMATION-CARRYING MEDIUM

(76) Inventors: Andrei Vladimirovich Tropillo, Sankt-Peterburg (RU); Igor Vitalievich Masol, Kiev (UA)

Correspondence Address: NEXSEN PRUET, LLC, P.O. BOX 10648, GREENVILLE, SC, 29603, US

(21) Appl. No.: 12/066,051

(22) PCT Filed: Mar. 6, 2007
(86) PCT No.: PCT/RU07/00113

§ 371 Date: Jun. 2, 2008

(51) Int. Cl. G11B 3/70

(52) U.S. Cl. 369/277; G9B/3.103

(57) ABSTRACT

The present invention relates to disc-shaped information-carrying media for storage and reproduction of audio-, video- and other types of information in a digital form. The disc-shaped information-carrying medium comprises at least a substrate with a matching bore in its central area for locking said medium in a reading device, said substrate having a first side and a second side opposite thereto, on at least said first side of said substrate a first information area is provided for information storage and/or recording and reading such information using a laser beam. According to a first embodiment said substrate thickness at least within said first information area does not exceed 0.8 mm, said substrate central area is provided with N>1 ending protrusions projecting over said substrate first side and facilitating locking said medium in a reading device drive. According to a second embodiment in addition to said N protrusions on said first side, a circular recess is provided within said central area on said substrate second side, limited between the diameters of 15 mm and 22 mm. According to a third embodiment in addition to said N ending protrusions, a flat circular protrusion is provided within said central area on said substrate second side, limited between the diameters of 15 mm and 40 mm. According to a fourth embodiment said substrate comprises two flat circular protrusions provided in the general cased within the diameters of 15 mm and 40 mm, one protrusion on each substrate side. This configuration of the medium ensures its compatibility with most of modern optical media reading/recording devices, capability of storing and/or recording and/or rewriting 4.7 Gb of information and more, low birefringence and read/write error rate.

### TECHNICAL FIELD

The present invention relates to disc-shaped information-carrying media for storage and reproduction of audio-, video- and other types of information in a digital form.

### PRIOR ART

At present, well known and widely used are disc-shaped information-carrying media, i.e. high-density digital versatile discs (DVD), each having a central matching bore and comprising a first disc-shaped cast substrate made from an optically transparent material (substantially, polycarbonate or polymethylmethacrylate), an additional disc-shaped cast substrate from the same material, as well as an adhesive layer for bonding said cast substrates together, and at least one information-carrying layer disposed on one of said substrate surfaces to provide information storage and/or recording, at least one of said substrates having a smooth and transparent external surface (see, for example, European Association for Standardizing Information and Computer Systems (EASICS, Standards Nos. 267, 268 (April 2001), 272 (June 1999), 279 (December 1998)). Depending on the number of recording layers single-sided and double-sided DVD (i.e. where information is read and/or recorded only on one or both sides of the medium) are available.

While said media able to store from 4.7 to 18 Gb of audio, video- and other types of digital information and reproduce this information on a modern equipment provided with an optical reading system operating within the wavelength range of 635 to 650 nm are currently known as the information storage and record media with the highest capacity, they have a number of limitations associated with their design and geometrical features.

In particular, any of the known media is extremely sensitive to flexural deformations resulting in microdisplacement of its substrates relative to each other and causing microseparation of the recording layer from the substrate and, hence, formation of defects, i.e. unreadable portions within the information area. Furthermore, a smooth transparent surface of this medium is not protected against damage (in particular, scratching) which also results in errors during eventual reproduction. Another limitation associated with a single-sided DVD is a poor adhesion of dyes used for applying color labels on the materials from which the additional substrate is made (polycarbonate or polymethylmethacrylate), as well as an early damage of the printing forms due to the single-sided medium geometrical features, which significantly limits its functionality and adversely affects the printing quality.

Furthermore, a considerable amount of raw materials (polycarbonate or polymethylmethacrylate) is consumed when manufacturing a DVD with two bonded substrates, and bonding itself as the most critical operation in terms of performance thereof is characterized by a poor operating temperature and takes a relatively long time (up to one third of the entire medium production cycle). Furthermore, after bonding the DVD substrates, closed air bubbles are formed between the same, which upon a change in the environmental conditions (for example, a temperature rise) may cause shearing deformations and affect the structural integrity resulting in a partial loss of the information recorded on the DVD. For all reasons given above, the reject rate in the manufacture of DVD may be as high as 10%.

The closest analog of the claimed invention is a disc-shaped information-carrying medium, i.e. a compact disc (CD) provided with a central bore for locking the medium in a reading device and comprising at least a substrate having a first side and a second side, as well as one information-carrying layer for information storage and/or recording and/or read with a laser beam (see, for example, EASICS Standard No. 130 (June 1996)).

The prior art medium is characterized by a relatively low capacity (usually, not more than 700 Mb), since its disc-shaped substrate has a thickness of 1.1 to 1.35 mm and the disc is reproduced on equipment operating at 780 nm, as the typical dimensions of the information pits and spacing thereof is considerably greater than those of a DVD, and accordingly their number is considerably less. Furthermore, a relatively high substrate thickness (1.2 mm) often causes general stresses to occur within the information area deep in the substrate resulting in birefringence and potential errors in reproduction, as well as destruction of the medium and damage of the reading device at the information reading rates of above 24×. Also, because of its relatively high weight and thickness, a CD is characterized by a relatively low resistance to flexural deformations, in general is rather fragile and is quite sensitive to collisions of its edge with firm surfaces resulting in scratching and spalling to form along the CD edge. Furthermore, like the above described DVD, the prior art CD is poorly protected against damage of its smooth transparent side when the medium is placed with said side down even on moderately rough surfaces (for example, on a table and the like), since it is provided only with one protrusion not more than 0.3 mm high provided on its transparent side 34 mm in diameter for stacking the discs. A relatively high consumption of raw materials when manufacturing the CD should be also noted, which is essential the same as the consumption of polycarbonate (polymethylmethacrylate) when manufacturing the DVD.

In view of the above, a need arises in providing a new information-carrying medium which would be free from most of the limitations of the prior art DVD and CD, while combining most of their advantages.

### SUMMARY OF THE INVENTION

The present invention relates to a high-density disc-shaped information-carrying medium with the new geometric properties, free from most of the limitations of the prior art DVD and CD and adapted for being read and/or recorded and/or rewritten on any modern equipment using a laser beam operating within the wavelength range of 635 to 650 nm, as well on the advanced equipment operating at 405-450 nm, and is further characterized by a substantially lower error rate in reproduction due to a lower stress within the central area deep in the substrate and also by a higher reliability of operation, compatibility with the modern information reading/recording devices and, furthermore, a higher manufacturability.

The above object is attained by providing a disc-shaped information-carrying medium comprising at least a substrate with a matching bore in its central area for locking said medium in a reading device, said substrate having a first side and a second side opposite thereto, on at least said first side of said substrate a first information area is provided for information storage and/or recording and reading such information using a laser beam, wherein according to a first embodiment said substrate thickness at least within said first information area does not exceed 0.8 mm, said substrate central area is provided with N>1 ending protrusions projecting over said substrate first side and facilitating locking said medium in a reading device drive.

Preferably, N protrusions project over said substrate first side by a value of H, where H is selected from the range of 0.15 to 0.75 mm.

Preferably, said protrusions are provided in a part of said substrate central area limited between the diameters D₁ and D₂, where 22 mm≦D₁<D₂≦40 mm. In a particular case, D₂ is preferably less than or equal to 37 mm.

In a particular case, said N protrusions over said first side are configured to be substantially identical.

In another particular case, said N protrusions comprise at least two groups of protrusions, with all protrusions within one group configured to be substantially identical.

Preferably, a projection of said protrusions over said substrate first side comprises a circle or an oval, with a maximum transverse size of said projection being selected from the range of 4 to 6 mm.

Preferably, an external surface of each of said protrusions comprises a part of a spherical and/or elliptical and/or cylindrical surface.

In a particular case, a recess is further provided in a central area on said second side of said medium. M partitions may be formed inside said recess, where M>1. Said partitions may extend radially or tangentially (obliquely).

In a particular case, a circular protrusion may be provided on said substrate second side, limited by the diameters of 33.5 mm and 34.5 mm and projecting over said substrate surface by not more than 0.4 mm.

Preferably, said substrate in said central area has a maximum value of thickness inclusive of the height of said N protrusions selected from the range of 1.0 to 1.5 mm.

In a particular case, a flat circular protrusion limited between an inner diameter and an outer diameter is further provided on said second side of said medium in said central area, wherein said inner diameter is greater than or equal to said matching bore diameter, and said outer diameter is less than 40 mm, said protrusion has a height providing said substrate maximum thickness in said central area inclusive of the height of said N protrusions within the range of 1.0 to 1.5 mm.

Preferably, an outer diameter of said substrate exclusive of tolerances is selected from the range of 80 mm inclusively to 120 mm inclusively. Most preferably, the outer diameter is 80 mm or 120 mm.

In a particular case, the medium comprises an outer circular protrusion on its first side, whose inner diameter is at a distance of not more than 2 mm from said medium outer edge, its width is not more than 2 mm, and the height by which it projects over the respective substrate side does not exceed 0.4 mm.

The above object is also attained by providing a disc-shaped information-carrying medium comprising at least a substrate with a matching bore in its central area for locking said medium in a reading device, said substrate having a first side and a second side opposite thereto, on at least said first side of said substrate a first information area is provided for information storage and/or recording and reading such information using a laser beam, wherein according to a second embodiment said substrate thickness at least within said first information area does not exceed 0.8 mm, said substrate central area is provided with N>1 ending protrusions projecting over said substrate first side and facilitating locking said medium in a reading device drive, and on said substrate second side a circular recess is provided in the central area, limited between the diameters D₃ and D₄, where 15 mm≦D₃<D₄≦22 mm.

In a particular case, said protrusions are configured to be substantially identical.

Preferably, a projection of said protrusions over said substrate first side comprises a circle or an oval, with a maximum transverse size of said projection being selected from the range of 4 to 6 mm.

In a particular case, said N protrusions comprise at least two groups of protrusions, with all protrusions within one group configured to be substantially identical. In at least one of said groups of protrusions, the projection of said protrusions on said substrate first side comprises a circle or an oval, with a maximum transverse size of said projection being selected from the range of 4 to 6 mm.

Preferably, said protrusions are limited between the diameters D₁ and D₂, where 22 mm≦D₁<D₂≦40 mm, with said protrusions of a maximum size rising above said substrate first side by a value of H, where H is selected from the range of 0.15 to 0.75 mm.

In a particular case, M>1 partitions may be formed inside said circular recess within said central area. Said partitions may extend radially or tangentially (obliquely).

Preferably, an outer diameter of said medium exclusive of tolerances is selected from the range of 80 mm inclusively to 120 mm inclusively. Most preferably, the outer diameter is 80 mm or 120 mm.

In a particular case, the medium comprises an outer circular protrusion on its first side, whose inner diameter is at a distance of not more than 2 mm from said medium outer edge, its width is not more than 2 mm, and the height by which it projects over the respective substrate side does not exceed 0.4 mm.

The above object is also attained by providing a disc-shaped information-carrying medium comprising at least a substrate with a matching bore in its central area for locking said medium in a reading device, said substrate having a first side and a second side opposite thereto, on at least said first side of said substrate a first information area is provided for information storage and/or recording and reading such information using a laser beam, wherein according to a third embodiment said substrate thickness at least within said first information area does not exceed 0.8 mm, said substrate central area is provided with N>1 ending protrusions projecting over said substrate first side and facilitating locking said medium in a reading device drive, and on said substrate second side a flat circular protrusion is provided, limited between the diameters D5 [symbol] D6, where D5<D6≦40 mm and D5 is greater than or equal to said matching bore diameter.

Preferably, said N protrusions on said first side in combination with said protrusion on said second side provide a thickness of said substrate in said central area, selected from the range of 1.0 to 1.5 mm.

Preferably, said protrusions on said first side are limited between the diameters D₁ and D₂, where 22 mm≦D₁<D₂≦40 mm, with said protrusions of a maximum size rising above said substrate first side by a value of H, where H is selected from the range of 0.15 to 0.75 mm.

In a particular case, D5 coincides with said matching bore diameter.

Preferably, an outer diameter of said medium exclusive of tolerances is selected from the range of 80 mm inclusively to 120 mm inclusively. Most preferably, the outer diameter is 80 mm or 120 mm.

In a particular case, the medium comprises an outer circular protrusion on its first side, whose inner diameter is at a distance of not more than 2 mm from said medium outer edge, its width is not more than 2 mm, and the height by which it projects over the respective substrate side does not exceed 0.4 mm.

Furthermore, the above object is attained by providing a disc-shaped information-carrying medium comprising at least a substrate with a matching bore in its central area for locking said medium in a reading device, said substrate having a first side and a second side opposite thereto, on at least said first side of said substrate a first information area is provided for information storage and/or recording and reading such information using a laser beam, wherein according to a fourth embodiment said substrate thickness at least within said first information area does not exceed 0.8 mm, and on at least one of the sides of said substrate a flat circular protrusion is provided, limited between the diameters D5 [symbol] D6, where D5<D6<40 mm and D5 is greater than or equal to said matching bore diameter, with a maximum thickness of said substrate within the area of said protrusion being selected from the range of 1.0 to 1.5 mm.

In a particular case, said medium comprises a first flat protrusion and a second flat protrusion, each being limited between the diameters D5 and D6, with said first protrusion being provided on said substrate first side and said second protrusion being provided on said substrate second side.

In a particular case, said first and second protrusions are arranged symmetrically about a horizontal axis of said medium.

In a particular case, said medium also has a second information area provided on said substrate second side.

In a particular case, D5 coincides with said matching bore diameter, and D6 may not exceed 38 mm.

Preferably, an outer diameter of said medium exclusive of tolerances is selected from the range of 80 mm inclusively to 120 mm inclusively. Most preferably, the outer diameter is 80 mm or 120 mm.

In a particular case, the medium comprises an outer circular protrusion on at least one of its sides, whose inner diameter is at a distance of not more than 2 mm from said medium outer edge, its width is not more than 2 mm, and the height by which it projects over the respective substrate side does not exceed 0.4 mm.

In a particular case, said medium may comprise two outer circular protrusions, one of which projecting over the first side and the other over the second side of said substrate.

All embodiments of the invention relates to a thin information-carrying medium in the form of a disc (hereinafter referred to as a “disc”), on which video-audio- or other information in a digital form is or may be applied. Such information may be then read from this medium using known and advanced optical systems based on the known and advanced lasers (red, violet or blue light lasers, respectively). The disc may be both a single- and a double-sided disc (in the latter case, it may comprise two information areas (hereinafter also referred to as “layers”), respectively), and the information may read both from an information-carrying area adjacent to the laser and the one provided on the other side of the substrate.

In all embodiments of the invention the disc is based on a single substrate. This is because most of the DVD limitations are associated with bonding the two substrates in the process of its manufacture, whereby it appears appropriate to omit this operation and manufacture the medium similarly to CD, i.e. using only one substrate. To ensure the readability of such medium on the modern equipment using a laser beam operating within the wavelength range of 630 to 650 nm, the substrate thickness should be decreased at least in the area of the information-carrying layer (or layers), i.e. the information-carrying medium should be thinner as compared to DVD and CD.

Decreasing the substrate thickness in the information area from 1.1-1.2 mm, which is a standard thickness, to 0.8 mm and less makes it possible to decrease the typical pit dimensions and spacing thereof in the information area as compared to CD and to increase the recording density of information on the disc and to read this information with a laser beam operating at a wavelength of 635 to 650 nm, thereby achieving a total capacity of 4.7 Gb for the medium with a single information area (single-sided) and of about 9 Gb for a double-sided medium (for the discs with 120-mm outer diameter). Besides, since an information area conventionally occupies most of the medium space, making the substrate thinner at least within said area enables considerable reduction in the raw-materials consumption (polycarbonate or polymethylmethacrylate) required for manufacturing the medium and reduction in its weight, which in turn facilitates a drop in stresses deep in the substrate and lowering the information reading and/or recording error rate, and also results in an improved flexibility and, accordingly, a reduced fragility of the medium.

At the same time, it is also required to ensure locking the medium in a reading device drive.

For reading the prior art DVD and CD, the standard modern drives exert pressure to the central part of the disc, substantially, to the area between the diameters of 22 mm (sometimes, 25 mm) and 33 mm. According to the DVD and CD standards it is supposed that the medium within the pressure area (and even around the same) has a sufficient thickness (typically, 1.1 to 1.2 mm) and, therefore, stiffness. As a result, a significant pressure is applied to the media by the modern drives to ensure high reading rates.

As shown by the experimental results, firmly pressing a thin disc whose central and information area has a thickness of 0.8 mm and less and having a lower stiffness as compared to the conventional media, would cause its deformation (uplift of the disc edges, embedding of its central part and the like). This may render the information completely unreadable and/or even cause the disc to disintegrate as it rotates in the drive due to breaking (tangential) tensions originating deep in the substrate.

Therefore, when reducing the substrate thickness special means should be used for locking thin discs in the conventional drives adapted for stiffer DVD and CD. In doing so, it appears most obvious to modify the pressing means used in the drive so that a thin disc does not deform upon pressure is applied thereto. However, due to a large number of specific embodiments of the modern drives and, accordingly, of the lock mechanisms such a task seems extremely time consuming. Furthermore, one can safely assume that not all drives thus modified would efficiently lock conventional thicker and stiffer DVD and CD so that the field of application of such drives would considerably shrink. Therefore, an optimum solution would be to modify the central area of the thin disc itself so that it may be efficiently locked in the standard drives just as the prior art DVD and CD.

According to the first embodiment of the present invention local the ending protrusions (i.e. the open protrusions contrary to the closed circular, i.e. endless protrusions) may be provided on said first (uppermost when locked in the drive) side of said substrate, preferably between the diameters of 22 mm and 40 mm inclusively and preferably projecting over said substrate first side by a value selected from the range of 0.15 to 0.75 mm. The form of such local protrusions should preferably enable dyeing said substrate first side without damaging the substrate itself, as well as the color labeling means (in particular, doctor knives). It has been found that a partially spherical and/or cylindrical and/or elliptical or other substantially convex quadric surface is the optimum form of the protrusion external surface for achieving this object so that when any side of the disc is subject to dyeing the likelihood of damaging the labeling means is reduced.

Furthermore, providing heavy protrusions may cause the local areas with high internal stresses to form deep in the substrate resulting in a loss of strength, increased birefringence and, as a consequence, increased read and/or write error rate. Accordingly, it is proposed to provide the protrusions above a first side of the substrate such that a maximum dimension of the transverse projection of each of the protrusions onto this side (preferably, a diameter of the projected circle or a maximum distance between two points at the boundary of the projected oval) would lie within 4 to 6 mm. As shown by the tests, with such a width of the protrusions it is possible to ensure both a safe disc pressing in a standard drive and also a normal level of birefringence around the substrate central area.

In the second embodiment, in addition to the above described protrusions over the substrate first side, the medium according to the present invention comprises a circular recess provided in the central area on the substrate second side, which further enables equalization of the substrate thickness and reduces the likelihood of forming an increased internal stress within the central area. In order to render the required stiffness to the disc within the area of said recess, partitions (radial or tangential) are preferably provided therein.

According to the third embodiment of the invention N local ending protrusions are also provided on a first side of the disc, enabling locking the disc in the drive, and a flat circular protrusion (hub) rendering the required stiffness to the disc central area is provided on a second side of the disc. Said protrusion may extend from the disc central matching bore to the end of the central area (close to the central area edge) so that the pressure device load may be spread more evenly across the disc central area.

According to the fourth embodiment of the invention only one or two flat circular protrusions (hubs) may be provided in the central area on each of the substrate sides. Most preferably, two hubs are provided in case of a two-sided disc (with two information-carrying layers on each of its sides), if for ensuring the all-purpose disc locking (any side down) it is more appropriate to provide similar or identical surface geometry of the central area both on the first and the second substrate sides. Furthermore, providing one and, all the more, two hubs having the described characteristics would render the disc the required stiffness similar to that of the conventional media, such as DVD and CD. To avoid excess internal stresses occurring at the periphery of a protrusion or protrusions (hubs), these are preferably configured to project as little as possible over the substrate surface(-s) or may be provided in the discs whose substrate thickness within the information area is closer to the proposed limiting value of 0.8 mm.

Therefore, each of the disclosed embodiments enables locking the disc in the drives of most of the currently known reading/recording devices. Furthermore, excess stresses occurring deep in the substrate and birefringence within the central area and at its boundary with the information area (right within the lead-in area) may be minimized. In some of the embodiments enhanced stiffness is further rendered to the disc within its central area and/or its operation is facilitated where two information-carrying layers are present.

### BRIEF DESCRIPTION OF THE DRAWINGS

The above and other aspects of the invention, as well as its associated advantages will be further explained in more detail with reference to the attached drawings wherein:

FIG. 1 shows a partial axial cross-sectional view of a disc-shaped information-carrying medium according to a first embodiment of the invention;

FIG. 2 shows a plan view shown in FIG. 1;

FIG. 3 shows a partial axial cross-sectional view of a disc-shaped information-carrying medium according to second embodiment of the invention;

FIG. 4 shows a partial axial cross-sectional view of a disc-shaped information-carrying medium according to third embodiment of the invention;

FIG. 5 shows a partial axial cross-sectional view of a disc-shaped information-carrying medium according to fourth embodiment of the invention.

The reference numerals used on the drawing denote: 1—substrate, 1a—substrate first side, 1 [symbol] —substrate second side, 2—matching bore, 3—ending protrusions on the substrate first side, 4—substrate central boss, 5—protrusion for disc stacking, 6—external circular protrusion, 6′—external circular protrusion over the substrate first side, 7—recess on the substrate second side, 8—flat circular protrusion (hub) according to an embodiment of the invention, 8a and 8 [symbol] —first and second hubs disposed on the substrate first and second sides, respectively.

### PREFERRED EMBODIMENTS OF THE INVENTION

As shown in the drawings, the thin disc according to each of the embodiments comprises a substrate 1 made from a conventional optically transparent material (optical polycarbonate or polymethylmethacrylate) and having a first side 1a and a second side 1 [symbol] . For clarity, the first side 1a will be hereinafter referred to as an upper side and the second side 1 [symbol] as a lower side in terms of the spatial orientation of the substrate sides, in case of a disc with one information-carrying layer inserted in a reading device drive. It is understood that in case of a double-sided disc, each of the sides may act both as an upper and a lower side as the case may be.

The substrate 1 comprises two main areas: an information area I containing an information-carrying layer or layers and a central area C generally containing no information-carrying layers (nor even any part thereof) and providing mainly utilitarian functions like locking the disc in the drive, storing visual identification information relating to the disc and/or its manufacture and so on. The boundary between the information and central areas generally lies near the diameter of 40 mm.

The central area of the disc is provided with a matching bore 2 from the center of which all diameters essential for the disc structure are measured. It should be understood that for any diameters and their values further referred to herein, the center of all diameters is in the center of the matching bore 2 whose own diameter is generally 15 mm exclusive of all standard and fit tolerances.

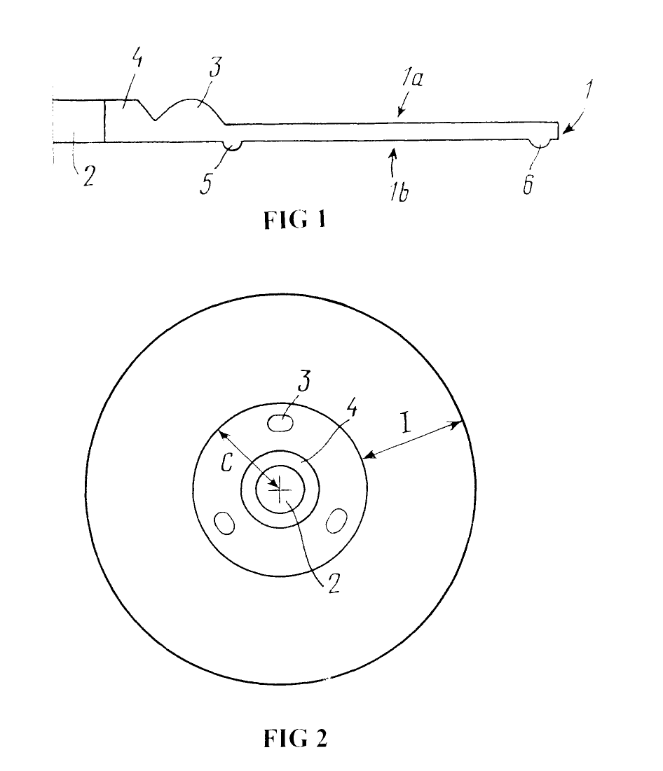

As further shown in FIG. 1-4, N local ending protrusions 3 are provided on the upper side 1a of the substrate 1 in three of the four embodiments of the disc. To ensure locking the disc in a reading or recording device drive said protrusions are preferably provided within the diameters of 22 mm and 40 mm. However, in various particular cases, the protrusion 3 may have its bottom part arranged both completely inside the circular area limited by said diameters (22 and 40 mm) and being in contact with one or even both boundaries thereof. In particular, a number of embodiments of the discs with protrusions over the first side 1a have been successfully tested, wherein in the first case said protrusions 3 were provided between the diameters 37 mm and 25 mm, in the second case, between the diameters 40 mm and 28 mm, in the third case—between the diameters 22 mm and 34 mm.

In the example illustrated in FIG. 2 three protrusions 3 are provided on the disc, although both less (2) and more (4, 5, 6, etc.) protrusions may be provided. It should be also noted that in the above example all protrusions 3 are identical, although in a particular embodiment of the invention two or more groups of protrusions may be distinguished among N protrusions 3, identical inside such groups and differing from the protrusions of other groups. Protrusions of various groups may differ, for example, in dimensions or form. In a particular embodiment, the protrusions 3 shown in FIG. 2 have a circular form in plan view (a projection thereof onto the substrate upper side 1a comprises a circle) with a diameter of about 4 to 6 mm. In another, also particular embodiment, in addition to the protrusions 3 shown in FIG. 2, on the first side 1a of the substrate 1 there may be provided protrusions forming a second group, each of said protrusions having a different (for example, oval) form in plan view and/or a lesser size than that of the protrusions 3. Such protrusions may be provided in the intervals between the protrusions 3 at the same diameter or be offset to another diameter (closer to of farther from the center). Preferably, N protrusions are spaced at equal angles (120° in case of the protrusions 3) for spreading evenly the loads and internal stresses.

Obviously, the number of N protrusions 3 over the first side 1a of the substrate 1 is preferably made very large so as not induce an increase in the internal stresses within the substrate central area, as well as the stresses and birefringence at its boundaries with the information area. The optimum number of protrusions is from three to six, and the larger is this number, the smaller should be (although not necessarily) the protrusions in size.

Furthermore, in the examples shown in FIG. 1-4, a circular boss is provided in the disc central area around the matching bore 2, said boss enabling safe locking the disc in the drives whose pressure means are based directly on a spindle (like, for example, most of the portable computer drives), as well as ensuring the required disc stiffness within the central area. As seen in FIG. 1, the boss 4 may have an external surface in the form of a part of a truncated cone surface (in other cases, a part of a cylindrical or other convex surface) and is disposed preferably within the diameter of 22 MM. The height by which the central boss 4 projects over the first side 1a of the substrate 1 is preferably equal to the height H by which the protrusions 3 rises above the same side 1a and is selected from the range of 0.15 mm to 0.75 mm. The total substrate thickness within the area where the boss 4 is provided (inclusive of this boss) is selected from the range of 1.0 mm to 1.5 mm. Similarly, the maximum substrate thickness within the central area inclusive of the N protrusions is also selected from the range of 1.0 to 1.5 mm. As shown by the tests, such thickness value inclusive of the protrusions 3 is sufficient for a safe locking and error-free disc reading in the drives of most of the standard players, as described above.

Moreover, as shown in FIG. 1, the disc according to the first embodiment may also comprise circular protrusions 5 and 6 provided on the substrate second side 1 [symbol] . The protrusion 5 is provided between the diameters of 33.5 and 34.5 mm and projects downwards from the surface of the second side 1 of the substrate 1 by a value not exceeding 0.4 MM (preferably, about 0.3 mm). The outer circular protrusion 6 has an inner limiting diameter not more than 2 mm less than the disc outer diameter (generally, either 120 or 80 mm), a width not exceeding 2 mm, and a height not exceeding 0.4 mm.

The protrusions 5 and 6 are configured to protect the substrate 1 surface on the second side 1 [symbol] (transparent in case of a single-sided disc) against damage possibly occurring due to a contact of the side 1 [symbol] with the rough surfaces (for example, a tabletop and the like). The outer circular protrusion 6 is also configured to strengthen a thin lateral edge of the disc and to ensure recognition of the disc in the slot-type devices (for example, car radio/cassette recorders and the like). It should be noted that in addition to the protrusion 6 on the second side 1 [symbol] of the substrate 1a medium having two information-carrying layers (on the substrate first and second sides) may have similar (and preferably symmetrical) protrusion 6′ on the first side 1a. However, no protrusions 5 and/or 6 and/or 6′ may be provided both in a single-sided and a double-sided disc.

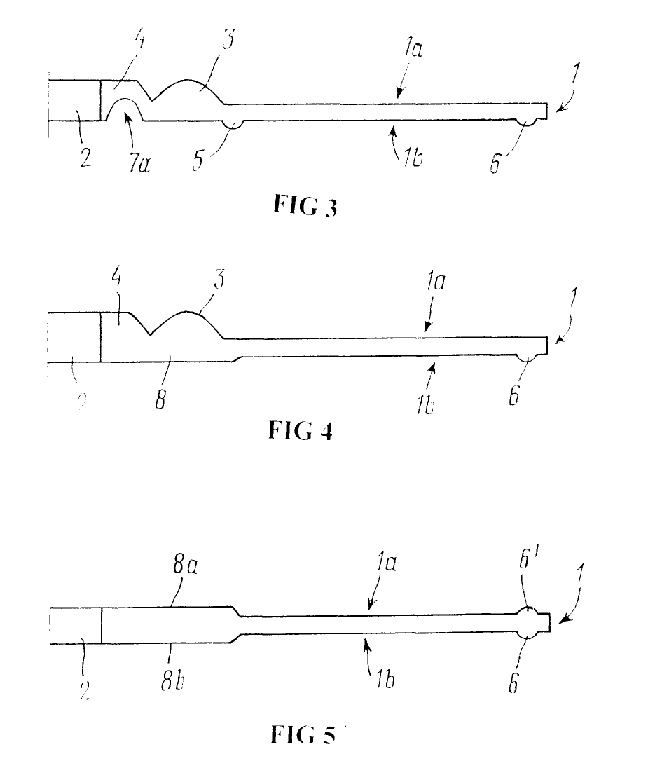

Furthermore, according to the third embodiment best shown in FIG. 3 a circular recess 7 may be provided in the disc central area between the diameters of 15 mm and 22 mm, configured to relieve the excess stresses within the central area and to strengthen the disc within said area. In the particular example shown in FIG. 3, the recess 7 is provided between the diameters of 16 mm and 21 mm, with its maximum depth (close to the diameter of 20 mm) is 0.6 mm thereby ensuring the average substrate thickness within the area of the boss 4 at the level of 0.6 to 0.8 mm.

However, providing the substrate 1 with the recess 7 may result in an increased flexibility of the substrate 1 within its central area, which may adversely affect locking the disc on a spindle with subsequent pressing thereof (the disc may deflect with its center down and its edges up). To enhance the stiffness of the disc central area provided with the recess 7, radial, tangential or other partitions may be provided within the recess 7, the number of which (in the general case) is M>1, preferably from 3 to 6.

According to the third embodiment of the invention in more detail shown in FIG. 4 the disc may be also rendered the required stiffness along with compatibility with the players. The medium according to this embodiment comprises the local ending protrusions 3 on the first side 1a of the substrate and one flat circular protrusion (hub) 8 projecting over the substrate second side and limited by the diameters D₅ and D₆, where D₅<D₆≦40 mm and D₅ is greater than or equal to the matching bore diameter. Preferably, D₅ coincides with the matching bore diameter and D₆ is less than or equal to 38 mm (in particular, successful tests have been performed of the discs wherein D₆ was selected from the range of 29 MM to 40 mm and [symbol] was, in particular, 39.5 mm, 38 mm, 34 mm, 32 mm and less). However, to avoid excess internal stresses occurring in the central area because of providing a heavy hub 8, the latter is preferably configured to project as little as possible over the substrate second side 1 [symbol] , but sufficiently for a safe locking the disc in a player (i.e. the maximum total substrate thickness within the central area inclusive of the protrusions 3 and the hub 8 should be within the range of 1.0 to 1.5 mm, preferably 1.1 to 1.4 mm). According to the third embodiment there is no need in providing the circular protrusion 5 and the recess 7, however the protrusion 6 and/or 6′ (for a double-sided disc) may be present.

According to the fourth embodiment shown in FIG. 5 the disc comprises one hub 8 or two hubs 8a (on the first side 1a of the substrate 1) and 8 [symbol] (on the second side 1 [symbol] of the substrate 1). The hubs 8, 8a or 8 [symbol] are configured similarly to the one describe above (in the general case, are provided within the diameters of 15 mm and 40 mm, in particular cases, within 15 to 38 mm) and for locking the disc in a player drive the total thickness within the area of providing the hub (hubs) should be within 1.0 to 1.5 mm (preferably, 1.1 to 1.4 mm) inclusive of the height of the hubs 8 (8a, 8 [symbol] ).

In case of one hub 8, it may be provided on the first side 1a or the second side 1 [symbol] of the substrate. The other side (1 [symbol] or 1a, respectively) is preferably smooth, however, for decreasing the internal stresses and birefringence at the boundary of the information area I and central area C it may be provided with one or more circular concentric recesses (not shown) which in turn may (but also may not) comprise stiffening partitions. However, notwithstanding the presence or absence of the recesses, the single hub 8 on one of the substrate 1 sides preferably should not project too much over the respective side to avoid a loss of the disc strength along the hub 8 periphery.

The single hub 8 is preferably provided in case of a single-sided or double-sided but non-reversible disc (i.e. where both the first and the second information-carrying layers are read through one substrate side). For a double-sided reversible disc (i.e. to be read first through one side and then through the other side), it is more preferable to provide two symmetrical hubs 8a and 8 [symbol] , each configured to project over the substrate 1 surface twice as little as the non-symmetrical single hub 8 described above. Such symmetrical arrangement of the slightly projecting hubs 8a and 8 [symbol] makes it possible to decrease the total internal stresses and the level of birefringence at the boundary of the areas I and C when vitrifying the disc upon its casting as compared to the case of the single hub 8.

In case of a double-sided reversible disc, it may also have two outer circular protrusions 6 and 6′, whose design is similar to the one described before. However, to ensure normal application of lacquer on both surfaces of a double-sided medium, instead of the circular protrusions 6 [symbol] 6′ the single-point protrusions may be also provided, whose width and height is similar to the width and height of the circular protrusions 6 [symbol] 6′.

It is clear to a person skilled in the art that the disc according to any of the described embodiments may have one or two information-carrying layers (on one or both sides of the substrate 1), each read by a laser beam through the opposite side of the substrate 1 or through the side whereon this layer is provided (a double-sided disc may be ether reversible or non-reversible). Each of such layers may be both prerecorded and recordable or rewritable, which may be readily achieved using the state-of-the-art materials and methods for recording/rewriting information on the optical media. It may be only emphasized that for a double-sided prerecorded disc each layer of which is read through the opposite substrate side (applicable mainly for red light laser-based reading/recording systems) the metallization layer should reflect from 5% to not more than 75% of the incident coherent radiation. For a disc whose information-carrying layers are read through the same side (for example, for the recently developed blue-light laser-based systems) this requirement is not obligatory (in this case the substrate should not necessarily be transparent).

The information-carrying medium according to any of the embodiments may be produced by injection molding on the known equipment conventionally used for CD production (single-sided disc) or DVD production (preferably double-sided disc) according to the known compression molding process, with minor changes made in the modes of performing separate stages and insignificant equipment improvements associated with the novel design of the medium according to the present invention.

At the first stage, the substrate 1 is produced by injection compression molding, for example, from optical polycarbonate (in particular, Macrolon™ by Bayer, Lexan™ by General Electric, Lupilon™ by Mitsubishi or others) used for producing CD and DVD. In the manufacture of prerecorded media, an information-carrying microrelief in the form of a combination of pits is provided on one (or both) of the substrate sides (within the information area I) by means of a prearranged matrix (matrices). In particular, for further use of the medium in the standard reading systems using the red light laser, the matrices may be utilized with the information recorded at a constant linear velocity (CLV) and a track pitch of 0.4 μm and more. In the manufacture of recordable or rewritable media, the appropriate spiral tracks with a format for recording/rewriting/reading information should be provided in the process of molding.

Obviously, to obtain the required relief of the first side 1a and/or the second side 1 [symbol] of the substrate (providing protrusions 3, boss 4, circular or single-point protrusions 6, 6′, recess 7, partitions within the recess, hubs 8, 8a, 8 [symbol] ), the respective surface of the die mold should have depressions/recesses completely corresponding by their dimensions and location to the required relief characteristics of the protrusions, partitions and/or recesses of the disc molded according to the invention. Therefore, the new geometry of the medium may be obtained by changing substantially only one unit of the optical media production line. Furthermore, to avoid the excess stresses within the central area of the medium and, accordingly, to reduce birefringencee within the information area lead-in, the initial injection speed of polycarbonate may be reduced at least two times, and when forming the information area the injection speed may be brought up to the standard value.

After molding, the substrate is cooled and then the layers are applied to ensure storage and or recording and or reproduction of information.

In particular, in the manufacture of a prerecorded medium, at least a part containing the information-carrying microrelief of the substrate surface is vacuum metallized with aluminum or other reflecting material to form a reflecting layer. It should be emphasized that in this case both the entire surface and only a part thereof including the portion with the microrelief thereon may be metallized. Then, a layer of a photopolymerizable lacquer commonly used for this purpose is applied on the metallized medium surface using a standard centrifugal device (centrifuge) and thereafter the lacquer is solidified with ultraviolet light in a UV furnace. In the manufacture of recordable or rewritable media, the changes in above process will involve only applying additional layers between the reflecting layer and the substrate surface, which may be done by conventional methods known in the art. In the manufacture of a double-sided medium, a thin layer of an optically transparent material is applied on both substrate sides rather than said photopolymerizable lacquer.

Then the medium quality is controlled at a testing station, whereupon rejection of the media is made based on the scanning and detection of optical defects. The successfully tested media may be then dyed by applying one or more layers of a dye, each with a thickness of 10-30 μm onto the lacquer layer and/or directly onto polycarbonate. As a result, a color label is obtained, which may provide information about the medium content, its total capacity, comprise manufacturer identification marking (trademark) and so on. The dyed discs are preferably further rejected based on the error rate and dyeing quality by means of an automated control station.

The product cycle duration (exclusive of dyeing) is about 4 sec., which is more than twice as little as the product cycle duration for a single-sided 4.7-Gb DVD. Furthermore, having the outer diameter of about 120 mm, the disc according to the invention has a weight of about 8.5 g, which is nearly twice as little as the weight of a DVD with a similar diameter. Therefore, nearly twofold saving of the raw material (polycarbonate) is achieved as compared to DVD. At the same time, a recording density comparable to that of a DVD is provided, nearly eight times higher than the recording density of a CD whose weight and dimensional features are similar to those of the medium according to the invention. Furthermore, the inventive medium is characterized by a higher reliability of operation as compared to the prior art CD and DVD, including improved protection against accidental damage of the information area, as well as a higher manufacturability because of the efficient and cost-effective use of the conventional equipment and materials commonly used in the art.

### INDUSTRIAL APPLICABILITY

The invention is suitable for various applications for storage and recording from 4.7 Gb (for a single-sided medium) to nearly 10 Gb (for a double-sided medium) of audio-video information and other types of data using the available state-of-the-art equipment for reproduction/recording DVD-media (at a laser radiation wavelength of 630 to 650 nm), as well as from 15 Gb (for a single-sided medium) and more using the advanced equipment (operating at a wavelength of 405 to 450 nm and shorter). The media may be manufactured on the standard equipment used for producing CD- and DVD-media, with insignificant modifications of the die mold, auxiliary equipment and minor changes in the molding condition, associated with the new geometrical features of the medium according to the invention.

1. A disc-shaped information-carrying medium comprising at least a substrate with a matching bore in its central area for locking said medium in a reading device, said substrate having a first side and a second side opposite thereto, on at least said first side of said substrate a first information area is provided for information storage and/or recording and reading such information using a laser beam, characterized in that said substrate thickness at least within said first information area does not exceed 0.8 mm, said substrate central area is provided with N>1 ending protrusions projecting over said substrate first side and facilitating locking said medium in a reading device drive.

2. The medium as claimed in claim 1, characterized in that said N protrusions project over said substrate first side by a value of H, where H is selected from the range of 0.15 to 0.75 mm.

3. The medium as claimed in claim 2, characterized in that said protrusions are provided in a part of said substrate central area limited between the diameters D₁ and D₂, where 22 mm≦D₁<D₂≦40 mm.

4. The medium as claimed in claim 3, characterized in that D2≦37 mm.

5. The medium as claimed claim 2, characterized in that said N protrusions over said first are configured to be substantially identical.

6. The medium as claimed in claim 2, characterized in that said N protrusions comprise at least two groups of protrusions, with all protrusions within one group configured to be substantially identical.

7. The medium as claimed in claim 2, characterized in that a projection of said protrusions over said substrate first side comprises a circle or an oval, with a maximum transverse size of said projection being selected from the range of 4 to 6 mm.

8. The medium as claimed in claim 2, characterized in that an external surface of each of said protrusions comprise a part of a spherical and/or elliptical and/or cylindrical surface.

9. The medium as claimed in claim 1, characterized in that recess is further provided in a central area on said second side of said medium.

10. The medium as claimed in claim 9, characterized in that M partitions may be formed inside said recess, where M>1.

11. The medium as claimed in claim 1, characterized in that a circular protrusion may be provided on said substrate second side, limited by the diameters of 33.5 mm and 34.5 mm and projecting over said substrate surface by not more than 0.4 mm.

12. The medium as claimed in claim 1, characterized in that said substrate in said central area has a maximum value of thickness inclusive of the height of said N protrusions selected from the range of 1.0 to 1.5 mm.

13. The medium as claimed in claim 1, characterized in that a flat circular protrusion limited between the inner and an outer diameters is further provided on said second side of said medium in said central area, wherein said inner diameter is greater than or equal to said matching bore diameter, and said outer diameter is less than 40 mm, said protrusion has a height providing said substrate maximum thickness in said central area inclusive of the height of said N protrusions within the range of 1.0 to 1.5 mm.

14. The medium as claimed in claim 13, characterized in that its outer diameter exclusive of tolerances is selected from the range of 80 mm inclusively to 120 mm inclusively.

15. The medium as claimed in claim 14, characterized in that the medium comprises an circular protrusion on its first side, whose inner diameter is at a distance of not more than 2 mm from said medium outer edge, its width is not more than 2 mm, and the height by which it projects over the respective substrate side does not exceed 0.4 mm.

16. A disc-shaped information-carrying medium comprising at least a substrate with a matching bore in its central area for locking said medium in a reading device, said substrate having a first side and a second side opposite thereto, on at least said first side of said substrate a first information area is provided for information storage and/or recording and reading such information using a laser beam, characterized in that said substrate thickness at least within said first information area does not exceed 0.8 mm, said substrate central area is provided with N>1 ending protrusions projecting over said substrate first side and facilitating locking said medium in a reading device drive, and on said substrate second side a circular recess is provided in the central area, limited between the diameters D₃ and D₄, where 15 mm≦D₃<D₄≦22 mm.

17. The medium as claimed in claim 16, characterized in that said protrusions are configured to be substantially identical.

18-24. (canceled)

25. A disc-shaped information-carrying medium comprising at least a substrate with a matching bore in its central area for locking said medium in a reading device, said substrate having a first side and a second side opposite thereto, on at least said first side of said substrate a first information area is provided for information storage and/or recording and reading such information using a laser beam, characterized in that said substrate thickness at least within said first information area does not exceed 0.8 mm, said substrate central area is provided with N>1 ending protrusions projecting over said substrate first side and facilitating locking said medium in a reading device drive, and on said substrate second side a flat circular protrusion is provided, limited between the diameters D5 [symbol] D6, where D5<D6≦40 mm and D5 is greater than or equal to said matching bore diameter.

26. The medium as claimed in claim 25, characterized in that said N protrusions said first side in combination with said protrusion on said second side provide a thickness of said substrate in said central area, selected from the range of 1.0 to 1.5 mm.

27. The medium as claimed in claim 26, characterized in that said protrusions on said first side are limited between the diameters D₁ and D₂, where 22 mm≦D₁<D₂≦40 mm, with said protrusions of a maximum size rising above said substrate first side by a value of H, where H is selected from the range of 0.15 to 0.75 mM.

28-39. (canceled)
